(19) United States
(12) Patent Application Publication
(10) Pub. No.: US 2026/0224059 A1
(43) Pub. Date: Aug. 6, 2026

(54) THERMORESISTANT PLA KNIFE/FORK/SPOON AND METHOD FOR PREPARING SAME

(71) Applicant: Taizhou Corn Environmental Protection Technology Co., Ltd., Taizhou (CN)

(72) Inventors: Wenguang LI, Midlothian, VA (US); Yonglei LIU, Linyi (CN); Qizao CHEN, Taizhou (CN); Yang TAO, Taizhou (CN); Qian HU, Taizhou (CN); Yujie JIN, Taizhou (CN); Guochao HUANG, Taizhou (CN); Yuting ZHU, Taizhou (CN)

(73) Assignee: Taizhou Corn Environmental Protection Technology Co., Ltd., Taizhou (CN)

(21) Appl. No.: 18/988,892

(22) Filed: Dec. 20, 2024

Related U.S. Application Data
(63) Continuation of application No. PCT/CN2023/085163, filed on Mar. 30, 2023.

(30) Foreign Application Priority Data
Jun. 20, 2022 (CN) 202210700306.2

(51) Int. Cl. A47G 21/02; A47G 21/04; B29B 9/06; B29C 45/00; B29C 71/00; B29K 67/00; B29K 303/08; C08K 3/34; C08K 5/098; C08K 5/11; C08L 67/04

(52) U.S. Cl. CPC A47G 21/02; A47G 21/04; B29B 9/06; B29C 45/0013; B29C 71/009; C08K 3/34; C08K 5/098; C08K 5/11; C08L 67/04; B29K 2067/046; B29K 2303/08; B29K 2995/0041

(57) ABSTRACT

The present disclosure relates to the technical field of tablewares, and particularly, to a method for preparing a thermoresistant PLA knife/fork/spoon. The method includes the following steps: preparing a knife/fork/spoon preform from a PLA knife/fork/spoon raw material via injection molding using an injection molding machine, the knife/fork/spoon preform includes PLA that is not completely crystallized; and subjecting the knife/fork/spoon preform to carbon dioxide soaking treatment at constant temperature and pressure to crystallize the uncrystallized PLA in the knife/fork/spoon preform, so as to obtain a PLA knife/fork/spoon product with a temperature resistance of 65° C. or above. The present disclosure further provides a thermoresistant PLA knife/fork/spoon. The knife/fork/spoon is a microfoaming product with a density reduced by 5% to 30% relative to the knife/fork/spoon preform and the knife/fork/spoon has a temperature resistance of 65° C. or above.

### CROSS-REFERENCE TO RELATED APPLICATIONS

The present disclosure is a continuation application of International Application No. PCT/CN2023/085163, filed on Mar. 30, 2023, which claims priority to Chinese Patent Application No. 202210700306.2, filed on Jun. 20, 2022. The disclosures of the above-mentioned applications are hereby incorporated by reference in their entireties.

### TECHNICAL FIELD

The present disclosure belongs to the technical field of tableware, and relates to a thermoresistant PLA knife/fork/spoon and a method for preparing the same.

### BACKGROUND

Knives/forks/spoons are most common among the tableware. Plastic tableware has become a symbolic product of the development of modern social civilization because it is cheap, non-toxic and tasteless, clean and sanitary, and does not need to be cleaned before and after meals, disposable, easy to use, convenient to produce, and unlimited production capacity. The disposable plastic knife/fork/spoon has become an indispensable daily necessity, which brings great convenience to the dining activities such as for transportation or field work or a party held for thousands of people after various large-scale activities.

With the rapid pace of modern people's life and work, the emergence and continuous development of fast food and takeaway industry, the use of disposable plastic knife/fork/spoon is still growing rapidly. However, since most plastic knives/forks/spoons are made of traditional plastics (PS (polystyrene), PP (polypropylene), etc.), thousands of tons of plastic resources are consumed every year, and the waste pollutes the environment, they have become one of the disposable plastic products that are most urgently banned to be produced and sealed under the national “Plastic Ban”.

Nowadays, the disposable plastic knives/forks/spoons in the market are mostly produced from either PS or PP. PS knives/forks/spoons are hard in nature and transparent in appearance. PP knives/forks/spoons are hard in nature, resistant to bending, free of embrittlement and have good temperature resistance. Although they are inexpensive, easy to use, and have met the requirements of various catering food, they are conventional plastics that do not degrade and are not easily recycled (cost too much).

Biodegradable plastic PLA (polylactic acid) knives/forks/spoons are new products developed for tableware. Since PLA has comparable properties to traditional plastic PP, it is chosen as an alternative to PP raw material for tableware production. However, it is found that non-crystallized PLA tableware is too soft to meet the strength requirements, and is also thermoresistant and deformed when exposed to heat. The fully crystallized PLA tableware is thermoresistant, but it is brittle and susceptible to bending and embrittlement. It has been found that additives such as talc can not only nucleate and promote the crystallization of the PLA, improve the strength and hardness of the material, but also reduce the cost of raw materials; addition of flexible biodegradable polymers such as a copolymer of butylene adipate and butylene terephthalate (PBAT) or polybutylene succinate (PBS) can toughen and improve PLA bending and embrittlement. It can be seen that PLA knife/fork/spoon can meet the performance requirements of disposable plastic tableware through appropriate modification of reinforcement, toughening, anti-embrittlement, cost reduction of the PLA, and is expected to be developed as a substitute for traditional plastic tableware.

Most of the existing PLA knives/forks/spoons are injection molded products with a very short production cycle. In addition, glass transition temperature (50° C.-60° C.) of PLA is high, resulting in slow crystallization. Regardless of the formula, even with the addition of a nucleating agent, PLA injection molded articles typically are not crystallized completely. Not only the strength is not high, but also the product is deformed when exposed to heat, so the product can be stable in quality only after subsequent heat treatment. However, since the general heat treatment methods (drying tunnel, oven, hot blowing, infrared heating) are neither easy to achieve accurate control nor achieve uniformity, the product is easy to deform, quality fluctuates, and defective fraction and waste fraction are high. Even so, the heat-treated PLA knife/fork/spoon generally does not resist buckling and is susceptible to bending and brittle fracture. It can be seen that it is still a challenge for the tableware manufacturing industry to make PLA into a knife/fork/spoon product with excellent performance.

There are few research reports about thermoresistant PLA knife/fork/spoon. CN112778726A proposes a PLA thermoresistant knife/fork/spoon and a production method. Racemic polylactic acid is used as a PLA material to increase its glass transition temperature (Tg) and melting temperature (Tm); a nucleating agent is added to promote crystallization of the material; after injection molding and then performing a temperature drying tunnel crystallization, a PLA thermoresistant knife/fork/spoon product is obtained. However, as racemic polylactic acid is a product in which L-polylactic acid and D-polylactic acid are formed into special stereostructure, its production capacity is limited, and its current price is high, so it is not easy to make a large market scale. At present, most of thermoresistant PLA products such as PLA thermoresistant knife/fork/spoon in the market are prepared from raw materials with high melting point, rapidly crystallized PLA with nucleating agents and processing aids by the temperature drying tunnel recrystallization method. Since the temperature drying tunnel does not easily achieve uniform heating, the product is easy to deform, for this reason, recently, some people soak the injection molded products rapidly in hot water to crystallize PLA, but it is difficult to ensure that the product does not absorb water, and the intervention of trace water may become a hidden danger of subsequent aging deterioration of the product.

### SUMMARY

According to the differences in the prior art, the present disclosure provides a thermoresistant PLA knife/fork/spoon and a method for preparing the same. The thermoresistant PLA knife/fork/spoon provided herein has the advantages of resistance to high temperatures, bending and embrittlement and biodegradability, and thus represents a new generation of environment-friendly knife/fork/spoon products.

In order to solve the above technical problem, an object of the present disclosure is achieved by the following technical solutions: a method for preparing a thermoresistant PLA knife/fork/spoon, which includes the following steps:
(1) preparing a knife/fork/spoon preform from a PLA knife/fork/spoon raw material via injection molding using an injection molding machine, the knife/fork/spoon preform includes PLA that is not completely crystallized; and
(2) subjecting the knife/fork/spoon preform to carbon dioxide soaking treatment at constant temperature and pressure to crystallize the uncrystallized PLA in the knife/fork/spoon preform, so as to obtain a PLA knife/fork/spoon product with a temperature resistance of 65° C. or above (referred to as a highest thermoresistant temperature 65° C. or above).

In the above-mentioned method for preparing the thermoresistant PLA knife/fork/spoon, the raw material for PLA knife/fork/spoon in step (1) includes the following components by mass:
50%-80% of a major material;
0%-20% of an auxiliary material;
10%-30% of a filler; and
0%-5% of a modifier;
where the major material is PLA;
the auxiliary material is PBAT, PBS or a blend of PBAT and PBS; the auxiliary material may also be not added as required;
the filler is selected from any one or a combination of more than one of talc, calcium carbonate, silica, bentonite, coffee grounds, and bamboo powder; and
the modifier is selected from any one or a combination of more than one of a nucleating agent, an antioxidant, an antistatic agent, an antibacterial agent, a color masterbatch, a compatibilizer, a toughening agent, a lubricant, a release agent, a chain extender, or a crosslinking agent; the amount and type of the filler and the modifier added should not affect an effect of carbon dioxide, performance of the knife/fork/spoon and an environment-friendly concept; the modifier may also be not added as required.

In the method for preparing the thermoresistant PLA knife/fork/spoon described above, PLA is selected from a single brand or a blend of brands.

In the above-mentioned method for preparing the thermoresistant PLA knife/fork/spoon, particles prepared by an extrusion blending and pelletizing process are used as the raw material for PLA knife/fork/spoon in step (1).

In the above-mentioned method for preparing the thermoresistant PLA knife/fork/spoon, a method of the carbon dioxide soaking treatment in step (2) includes: placing PLA knife/fork/spoon preform in a temperature-adjustable closed container with high temperature and high pressure resistance, injecting the carbon dioxide into the closed container, and soaking at a constant temperature and under retained pressure, quickly releasing the pressure after the soaking, opening the container, taking out the sample, and cooling at room temperature to obtain a product; and the container with high temperature and high pressure resistance is any closed container that can be temperature-adjustable and pressure resistant.

In the above-mentioned method for preparing the thermoresistant PLA knife/fork/spoon, in step (2), a pressure retaining temperature is 45° C.-110° C., the pressure retaining pressure is 4-12 MPa, a pressure retaining time is 6-60 minutes, and a pressure release speed is 5-45 MPa/s.

In the method for preparing the thermoresistant PLA knife/fork/spoon described above, the carbon dioxide is a supercritical carbon dioxide fluid or a subcritical carbon dioxide fluid.

In the above-mentioned method for preparing the thermoresistant PLA knife/fork/spoon, different thermoresistant knife/fork/spoon products are obtained by adjusting the formula and soaking parameters respectively, and in general, with the same formula, the higher the pressure retaining temperature, the higher the temperature resistance of the resulting knife/fork/spoon product.

The products provided by the present disclosure are respectively:
a thermoresistant knife/fork/spoon product having a temperature resistance of 65° C. or above and below 100° C.; this product is suitable for use with western food and cold drinks;
a highly thermoresistant knife/fork/spoon product having a temperature resistance above 100° C.; and this product is suitable for use with hot drinks and hot dishes cooked with oil.

In the above-mentioned method for preparing the thermoresistant PLA knife/fork/spoon, a low-density knife/fork/spoon product is obtained by adjusting soaking parameters; alternatively, the pressure retaining pressure is 7 MPa or above and below 12 MPa, and the pressure release speed is 24 MPa/s or above; preferably, the pressure retaining pressure is 9 MPa or above and below 10.5 MPa, and the pressure release speed is 31 MPa/s or above; a density of the obtained knife/fork/spoon product is 0%-30% lower than a density of the knife/fork/spoon preform (excluding 0).

The present disclosure also provides a thermoresistant PLA knife/fork/spoon which is a microfoaming product. The knife/fork/spoon is a microfoaming product with a density reduced by 5% to 30% relative to the knife/fork/spoon preform, and the knife/fork/spoon has a temperature resistance of 65° C. or above.

The present disclosure has the following advantageous effects as compared with the prior art.

Firstly, the present disclosure provides a method for preparing a new PLA knife/fork/spoon. Under certain conditions of temperature and pressure, the carbon dioxide fluid can rapidly dissolve and penetrate into PLA knife/fork/spoon, which can eliminate internal stress caused by an orientation of the injection molded molecules, assist the movement of PLA macromolecular chains, and adjust spatial structure arrangement of PLA macromolecular chains without causing bending deformation of the knife/fork/spoon, PLA can be induced to complete crystallization, and the strength and temperature resistance of PLA knife/fork/spoon can be changed; and better results are obtained when supercritical fluid carbon dioxide is used as the carbon dioxide fluid.

Secondly, the present disclosure has better anti-embrittlement and anti-tear performance, general heat treatments (oven, temperature drying tunnel) usually produce large PLA spherulites; however, CO₂ treatment can improve the brittle fracture performance of PLA because small PLA crystallites can be obtained.

Thirdly, the present disclosure can generate micro-nano cell structure inside PLA knife/fork/spoon through rapid pressure release and rapid gasification and expansion of carbon dioxide, so that the density of the product is reduced, the toughness is increased and the product can resist bending and embrittlement.

Fourthly, the process parameters of the present disclosure can be precisely controlled, and the product quality is stable; since the knife/fork/spoon preform is soaked in carbon dioxide, and the process parameters can be precisely controlled, there can be uniformity among and within the products, and design of the shape of the products can be unchanged.

Fifthly, the temperature resistance of the present disclosure is adjustable, and is suitable for the use requirements of various cold and hot meals; PLA knife/fork/spoon of the present disclosure can generally resist a temperature above 65° C. and can be used in western food and cold drinks; PLA knife/fork/spoon can also resist 100° C. or above to meet the requirements of hot drinks and hot dishes cooked with oil.

Sixthly, the production efficiency of the present disclosure is high, after using the carbon dioxide treatment technology, since it is no longer limited by whether the injection molded preform is crystallized or not, the formula and composition of PLA knife/fork/spoon can be simplified, the production cycle of injection molded molding can be shortened, the preform is completely crystallized in the carbon dioxide soaking container for mass production, and the production efficiency of the final PLA knife/fork/spoon product can be improved by 10% or above.

Seventhly, the present disclosure can reduce the cost, since the carbon dioxide soaking treatment of the knife/fork/spoon can induce complete crystallization of the PLA, less or no nucleating agent is used, and crystallized PLA knife/fork/spoon can also be produced. Only one of these can reduce the costs for the raw materials by 10%. In addition, the knife/fork/spoon can also be made into a micro-nano cell structure, thereby reducing the amount of the raw materials and the production cost of the product. In addition, the present disclosure can use PLA of a general brand, which also contributes to a reduction in the production cost of the product.

Eighthly, in the present disclosure, PLA is used as a major material, and the thus-produced knife/fork/spoon product is biodegradable, and the waste after use does not cause environmental pollution.

Ninthly, the present disclosure helps to promote replacement of existing PP or PS knife/fork/spoon with PLA knife/fork/spoon, which reduces the difference in price between traditional plastic tableware and biodegradable plastic tableware while having a better appearance of being white or silvery white.

At last, the present disclosure also provides a new knife/fork/spoon, which is currently in the market in the form of a non-foamed knife/fork/spoon, but the knife/fork/spoon of the present disclosure is in a microfoaming form. During an in-depth study on the carbon dioxide fluid treatment for PLA knife/fork/spoon, the researchers found that the micro-foaming of PLA knife/fork/spoon achieved new characteristics, in addition to temperature resistance, it also had the function of resisting bending and embrittlement, so that the knife/fork/spoon could prevent the accidental embrittlement during chewing when it is used, making people feel more comfortable and safe.

### DETAILED DESCRIPTION OF THE EMBODIMENTS

The present disclosure is further illustrated by the following description of specific embodiments, which are not to be construed as limiting the present disclosure, and various modifications and improvements can be made by a person skilled in the art without departing from the basic idea of the present disclosure.

A method for determining each test data in this example is as follows.

A method for determining a density of the knife/fork/spoon in this example is as follows.

According to the principle of Archimedes' buoyancy, by using a drainage method, samples of the knife/fork/spoon are respectively weighed to obtain a weight in air (W₁) and a weight in water (W₂), wherein the difference between the weights is a buoyancy (F) experienced by the sample, which is equal to a volume of a sample (Vₛ) multiplied by a density of water (d_{w}). A density (dₛ) of the sample can then be calculated.

$$F = {W}_{1} - {W}_{2} = {d}_{w} * {V}_{s}$$

$${d}_{s} = {W}_{1} / {V}_{s} = {d}_{w} * {W}_{1} / ( {W}_{1} - {W}_{2} )$$

In the example, the method for calculating a density reduction percentage of the knife/fork/spoon is as follows.

A density of the knife/fork/spoon preform is d₀ and a density of the knife/fork/spoon product is d_{f}, after carbon dioxide treatment, micro-nano cell structures are generated inside the knife/fork/spoon, and the density reduction percentage X thereof is:

$$X ( \% ) = ( {d}_{0} - {d}_{f} ) / {d}_{0} * 100$$

The method for determining temperature resistance of the knife/fork/spoon in this example is as follows:

200 grams of glass beads are measured and placed into a 500 ml beaker, about ¾ of the beaker of water is poured into the beaker, the beaker is placed into a thermostatic water bath with a set temperature, a thermometer is inserted therein, when the temperature in the beaker reaches the desired temperature, the knife/fork/spoon is inserted into the beaker, after waiting for 5 seconds, the glass beads in the beaker are scooped continuously with a spoon, and the action is repeated 20 times, and the state of the knife/fork/spoon during and after stirring is observed. If the knife/fork/spoon becomes soft during stirring and cannot be stirred smoothly, or deforms seriously after stirring, the test may be ended, and it is determined that the knife/fork/spoon cannot resist the temperature. If the knife/fork/spoon can still maintain the original state, it is determined that the knife/fork/spoon can resist the temperature. When the temperature reaches 100° C. and the spoon can still resist temperature, the highest temperature resistance of the knife/fork/spoon to the temperature could reach 100° C. or above. In the examples, a plastic spoon (a total length of 140 mm for a spoon head and a spoon handle, 90 mm for the spoon handle) is chosen as a sample for testing the temperature resistance of the knife/fork/spoon.

The method for determining bending and fracture resistance of the knife/fork/spoon in this example is as follows:
a Chatillon CS225 type dynamometer is used with a sample manual mechanical clamp, connected with a bending pressure head having an arc surface diameter of 10 mm and a length of 50 mm, and a plastic spoon (a total length of 140 mm for a spoon head and a spoon handle, 90 mm for the spoon handle) is chosen as a sample for testing the bending and fracture of the knife/fork/spoon. The test method is as follows: the weakest point of the spoon handle (100 mm from the spoon head) is fixed at the clamp, with a concave side of the spoon head facing upwards, the bending pressure head (almost touching) is pressed on a spoon handle 70 mm from the spoon head (i.e., 30 mm from an edge of the clamp to the pressure head), pressed at a speed of 300 mm/minutes to a position where the spoon handle is bent at an angle of 60° (the pressing distance is approximately 50 mm), and it is observed whether the spoon handle is fractured and a bending angle of the spoon handle when it is fractured (the pressing distance). If there is no fracture when the spoon handle is pressed and bent, it is determined that the spoon is resistant to bending and embrittlement; if the lower spoon handle is bent and broken, it is determined that the spoon is not resistant to bending and embrittlement.

The raw material sources in the examples of the present disclosure are as shown in Table 1-1:

TABLE 1-1
Raw materials and source

| | Brand or | |
|---|---|---|
| Compounds | specification | Source |
| PLA | 201, 210, 290 | Zhejiang Hisun |
| | | Biomaterials Co., Ltd. |
| PBAT | KHB21AP11 | Kanghui New Material |
| | | Technology Co., Ltd. |
| PBS | 803S | Xinjiang Blue Ridge |
| | | Tunhe Sci.&Tech. Co., |
| | | Ltd. |
| Talcum powder | 1250 Meshes | Commercially available |
| Tributyl | LM30 | Lemon-flex Company |
| citrate (TBC) | | Limited China |
| Calcium stearate | First grade | Hangzhou |
| | | Oleochemicals Co., Ltd. |

TABLE 1-2
Raw material formula, density and temperature
resistance of PLA knife/fork/spoon

| | | | | | | | | Temperature |
|---|---|---|---|---|---|---|---|---|
| | | | | | | | | resistance |
| | | | | | | | | (Highest |
| | | | | | | Calcium | | temperature |
| Formula | PLA | PBAT | PBS | Filler | TBC | stearate | Density | resistance) |
| number | (%) | (%) | (%) | (%) | (%) | (%) | (g/cm³) | (° C.) |
| 01 | 50 | 20 | | 30 | 1 | 1 | 1.488 | 50 |
| 02 | 60 | 10 | | 30 | 1 | 1 | 1.491 | 50 |
| 03 | 60 | 20 | | 20 | 0.5 | 1 | 1.414 | 50 |
| 04 | 80 | 10 | | 10 | 0.2 | 1 | 1.327 | 50 |
| 05 | 70 | | | 30 | 1 | | 1.471 | 50 |
| 06 | 65 | 5 | | 30 | 1 | | 1.477 | 50 |
| 07 | 65 | | 5 | 30 | 1 | | 1.477 | 50 |
| 08 | 60 | 5 | 5 | 30 | 1 | | 1.484 | 50 |
| 09 | 70 | | | 30 | 1 | | 1.490 | 55 |
| 010 | 68 | 2 | | 30 | 1 | | 1.478 | 50 |

TABLE 1-3
Composition of PLA in the raw material
formula of knife/fork/spoon

| Formula | 201PLA | 210PLA | 290PLA | PLA |
|---|---|---|---|---|
| number | (%) | (%) | (%) | (%) |
| 01 | 50 | | | 50 |
| 02 | 60 | | | 60 |
| 03 | 60 | | | 60 |
| 04 | 80 | | | 80 |
| 05 | 45 | | 25 | 70 |
| 06 | 40 | | 25 | 65 |
| 07 | 40 | | 25 | 65 |
| 08 | | 60 | | 60 |
| 09 | | | 70 | 70 |
| 10 | | 68 | | 68 |

In the examples, PLA knife/fork/spoon samples are prepared as follows.

### (1) Preparation of PLA Knife/Fork/Spoon Preforms:

According to the composition of the formulas in Tables 1-2 and 1-3 respectively, one or two blended PLAs are used as the major material, PBAT or PBS or a blend of PBAT and PBS as the auxiliary material (no auxiliary material may be added), talc is used as a filler, and TBC (plasticizer) and calcium stearate (lubricant) are used as modifiers to prepare a total of 10 formulas of PLA knife/fork/spoon preforms numbered from 01-10. The preparation method is as follows: the raw material particles of various formulas are prepared by an extrusion blending and pelletizing process. These raw material particles are then subjected to an injection molding process using an injection molding machine to prepare PLA knife/fork/spoon preforms of a predetermined shape, size and weight. These PLA knife/fork/spoon preforms are not thermoresistant (highest temperature resistance below 60° C.).

### (2) Preparation of PLA Knife/Fork/Spoon Samples:

PLA knife/fork/spoon preforms are soaked in a carbon dioxide closed container (mold) at constant temperature and pressure for a predetermined time, then rapid pressure release to open the mold is performed, the samples are taken out and cooled at room temperature, so as to obtain PLA knife/fork/spoon product. The carbon dioxide treatment process conditions for PLA knife/fork/spoon with different formulas are as shown in Table 2.

TABLE 2
Carbon dioxide treatment processing conditions and performance test of PLA knife/fork/spoon

| | | | | | | | | Temperature | |
|---|---|---|---|---|---|---|---|---|---|
| | | | | | | | | resistance | Bending |
| | | Pressure | Pressure | Pressure | Pressure | | | (highest | and embrit- |
| | | retaining | retaining | retaining | release | Product | Density | temperature | tlement |
| Exam- | For- | Temperature | pressure | time | speed | density | reduction | resistance) | resistance |
| ple # | mula # | (° C.) | (MPa) | (min) | (MPa/s) | (g/cm³) | (%) | (° C.) | (mm) |
| 1 | 01 | 70 | 4.5 | 60 | 16 | 1.492 | −0.3 | 65 | 50 |
| | 02 | 70 | 4.5 | 60 | 16 | 1.499 | −0.5 | 70 | 50 |
| | 03 | 70 | 4.5 | 60 | 16 | 1.411 | 0.2 | 70 | 50 |
| | 04 | 70 | 4.5 | 60 | 16 | 1.335 | −0.6 | 65 | 50 |
| 2 | 01 | 85 | 4 | 20 | 14 | 1.486 | 0.1 | 65 | 50 |
| | 02 | 85 | 4 | 20 | 14 | 1.498 | −0.5 | 80 | 50 |
| | 03 | 85 | 4 | 20 | 14 | 1.408 | 0.4 | 75 | 50 |
| | 04 | 85 | 4 | 20 | 14 | 1.326 | 0.1 | 65 | 50 |
| 3 | 05 | 65 | 4.5 | 40 | 16 | 1.474 | −0.2 | 90 | 50 |
| | 06 | 65 | 4.5 | 40 | 16 | 1.480 | −0.2 | 80 | 50 |
| | 07 | 65 | 4.5 | 40 | 16 | 1.482 | −0.3 | 90 | 50 |
| | 08 | 65 | 4.5 | 40 | 16 | 1.491 | −0.5 | 80 | 50 |
| | 09 | 65 | 4.5 | 40 | 16 | 1.487 | 0.2 | 95 | 50 |
| | 010 | 65 | 4.5 | 40 | 16 | 1.476 | 0.1 | 90 | 50 |
| 4 | 05 | 105 | 4.5 | 10 | 16 | 1.477 | −0.4 | 95 | 23.2 |
| | 06 | 105 | 4.5 | 10 | 16 | 1.482 | −0.3 | 90 | 31.5 |
| | 07 | 105 | 4.5 | 10 | 16 | 1.480 | −0.2 | 95 | 31.2 |
| | 08 | 105 | 4.5 | 10 | 16 | 1.487 | −0.2 | 90 | 50 |
| | 09 | 105 | 4.5 | 10 | 16 | 1.485 | 0.3 | >100 | 20.3 |
| 5 | 05 | 50 | 10 | 60 | 34 | 1.045 | 29.0 | 70 | 50 |
| | 09 | 50 | 10 | 60 | 34 | 1.106 | 25.8 | 70 | 50 |
| 6 | 05 | 60 | 9.5 | 15 | 33 | 1.288 | 12.4 | 70 | 50 |
| | 06 | 60 | 9.5 | 15 | 33 | 1.254 | 15.1 | 65 | 50 |
| | 07 | 60 | 9.5 | 15 | 33 | 1.310 | 11.3 | 65 | 50 |
| | 09 | 60 | 9.5 | 15 | 33 | 1.357 | 8.9 | 75 | 50 |
| | 010 | 60 | 9.5 | 15 | 33 | 1.320 | 10.7 | 70 | 50 |
| 7 | 05 | 70 | 8 | 30 | 28 | 1.340 | 8.9 | 70 | 50 |
| | 05 | 70 | 9.5 | 30 | 33 | 1.135 | 22.8 | 75 | 50 |
| | 05 | 70 | 11 | 30 | 38 | 1.036 | 29.6 | 75 | 50 |
| 8 | 05 | 85 | 9.5 | 8 | 33 | 1.335 | 9.3 | 95 | 34.3 |
| | 07 | 85 | 9.5 | 8 | 33 | 1.356 | 8.2 | 85 | 29.6 |
| 9 | 06 | 85 | 10 | 6 | 34 | 1.361 | 7.9 | 75 | 50 |
| | 09 | 85 | 10 | 6 | 34 | 1.335 | 10.4 | 95 | 20.8 |
| | 010 | 85 | 10 | 6 | 34 | 1.122 | 20.1 | 90 | 23.6 |

TABLE 3
Product density, temperature resistance, and bending and embrittlement
resistance after temperature oven treatment of PLA knife/fork/spoon

| | | Sample | | | Temperature | |
|---|---|---|---|---|---|---|
| | | crystal- | | | resistance | Bending |
| | | lization | | | (highest | and embrit- |
| | | heat | Product | Density | temperature | tlement |
| Comparative | For- | treatment | density | reduction | resistance) | resistance |
| Example # | mula # | condition | (g/cm³) | (%) | (° C.) | (mm) |
| 1 | 01 | 110° C., | 1.494 | −0.4 | ≤65 | 50 |
| | 02 | 10 minutes, | 1.501 | −0.7 | ≤80 | 28.4 |
| | 03 | ventilation oven | 1.419 | −0.4 | ≤75 | 50 |
| | 04 | | 1.338 | −0.8 | ≤65 | 50 |
| 2 | 05 | 110° C., | 1.472 | −0.1 | >100 | 21.4 |
| | 06 | 10 minutes, | 1.473 | 0.3 | ≤90 | 28.0 |
| | 07 | ventilation oven | 1.473 | 0.3 | ≤95 | 21.4 |
| | 08 | | 1.486 | −0.1 | ≤90 | 50 |
| | 09 | | 1.486 | 0.3 | >100 | 17.5 |
| | 010 | | 1.476 | 0.1 | ≤95 | 21.2 |

### Example 1

PLA knife/fork/spoon preforms with formula composition Nos. 01-04 are placed in a mold container at 70° C., carbon dioxide is injected into the container at a pressure of 4.5 MPa, the preforms are soaked at constant temperature and pressure for 60 minutes, rapid pressure release at a speed of 16 MPa/s is performed, the mold is opened to take out the samples, and the samples are cooled at room temperature to obtain PLA knife/fork/spoon product. The samples are tested for density, temperature resistance, and bending and embrittlement resistance and the results are as shown in Table 2. After carbon dioxide treatment, the densities of the samples are hardly changed, it is not shiny over the appearance of a mirror surface of respective samples, and the shapes of the samples are not significantly changed. The Nos. 01-04 knives/forks/spoons have a temperature resistance of 65° C. or below, while the Nos. 02 and 03 knives/forks/spoons have a temperature resistance of 70° C. or below; the samples are not broken in the bending resistance test.

### Example 2

PLA knife/fork/spoon preforms with formula composition Nos. 01-04 are placed in a mold container at 85° C., carbon dioxide is injected into the container at a pressure of 4 MPa, the preforms are soaked at constant temperature and pressure for 20 minutes, rapid pressure release at a speed of 14 MPa/s is performed, the mold is opened to take out the samples, and the samples are cooled at room temperature to obtain PLA knife/fork/spoon product. The samples are tested for density, temperature resistance, and bending and embrittlement resistance and the results are as shown in Table 2. After carbon dioxide treatment, the densities of the samples are hardly changed, it is not shiny over the appearance of a mirror surface of respective samples, and the shapes of the samples are not significantly changed except for the No. 04 sample, the Nos. 01 and 04 knives/forks/spoons have a temperature resistance of 65° C. or below, while the Nos. 02 and 03 knives/forks/spoons have a temperature resistance of 80° C. or below and 75° C. or below respectively; the samples are not broken in the bending resistance test.

### Comparative Example 1

PLA knife/fork/spoon preforms with formula composition Nos. 01-04 are placed in an oven at 110° C., performed constant-temperature ventilation treatment for 10 minutes, the oven is opened to take out the samples, and the samples are cooled at room temperature to obtain PLA knife/fork/spoon product. The samples are tested for density, temperature resistance, and bending and embrittlement resistance and the results are as shown in Table 3. After the ventilation oven treatment, the densities of the samples increase slightly (below 1%), and the samples significantly deform; the Nos. 01-04 knives/forks/spoons have a temperature resistance of 65° C. or below, while the Nos. 02 and 03 knives/forks/spoons have a temperature resistance of 80° C. or below and 75° C. or below respectively; the No. 02 sample is broken in the bending resistance test, while the other samples are not in the bending resistance test.

From the above Examples 1, 2 and Comparative Example 1, it can be seen that the temperature resistance of PLA knife/fork/spoon samples depends on the formula composition and can be varied between 65° C.-80° C., and the samples of the present disclosure can achieve the same temperature resistance effect as the samples undergone the conventional heat treatment, but the samples of the present disclosure can maintain the shapes of the samples substantially unchanged and can also resist bending and embrittlement.

### Example 3

PLA knife/fork/spoon preforms with formula composition Nos. 05-010 are placed in a mold container at 65° C., carbon dioxide is injected into the container at a pressure of 4.5 MPa, the preforms are soaked at constant temperature and pressure for 40 minutes, rapid pressure release at a speed of 16 MPa/s is performed, the mold is opened to take out the samples, and the samples are cooled at room temperature to obtain PLA knife/fork/spoon product. The samples are tested for density, temperature resistance, and bending and embrittlement resistance and the results are as shown in Table 2. After carbon dioxide treatment, the densities of the samples are hardly changed, it is not shiny over the appearance of a mirror surface of respective samples, and the shapes of the samples are not significantly changed. The Nos. 06 and 08 knives/forks/spoons have a temperature resistance of 80° C. or below, while the Nos. 05, 07 and 010 knives/forks/spoons have a temperature resistance of 90° C. or below. The No. 09 knife/fork/spoon has a temperature resistance of 95° C. or below, and all the samples of Nos. 05-010 are not broken in the bending resistance test.

### Example 4

PLA knife/fork/spoon preforms with formula composition Nos. 05-09 are placed in a mold container at 105° C., carbon dioxide is injected into the container at a pressure of 4.5 MPa, the preforms are soaked at constant temperature and pressure for 10 minutes, rapid pressure release at a speed of 16 MPa/s is performed, the mold is opened to take out the samples, and the samples are cooled at room temperature to obtain PLA knife/fork/spoon product. The samples are tested for density, temperature resistance, and bending and embrittlement resistance and the results are as shown in Table 2. After carbon dioxide treatment, the densities of the samples are hardly changed, it is not shiny over the appearance of a mirror surface of respective samples, and the shapes of the samples are not significantly changed. The Nos. 06 and 08 knives/forks/spoons have a temperature resistance of 90° C. or below, while the Nos. 05 and 07 knives/forks/spoons have a temperature resistance of 95° C. or below. The No. 09 knife/fork/spoon has a temperature resistance above 100° C. The No. 08 sample is not broken in the bending resistance test, while the Nos. 05, 07 and 09 samples are broken in the bending resistance test.

### Comparative Example 2

PLA knife/fork/spoon preforms with formula composition Nos. 05-010 are placed in an oven at 110° C., performed constant-temperature ventilation treatment for 10 minutes, the oven is opened to take out the samples, and the samples are cooled at room temperature to obtain PLA knife/fork/spoon product. The samples are tested for density, temperature resistance, and bending and embrittlement resistance and the results are as shown in Table 3. After ventilation oven treatment, the densities of the samples are hardly changed, it is not shiny over the appearance of a mirror surface of respective samples, and the shapes of the samples are not significantly changed. The Nos. 05 and 09 knives/forks/spoons have a temperature resistance above 100° C., while the Nos. 06 and 08 knives/forks/spoons have a temperature resistance of 90° C. or below; the Nos. 07 and 010 knives/forks/spoons have a temperature resistance of 95° C. or below; the samples are broken in the bending resistance test except for the No. 08 sample.

It can be seen from the above-mentioned Example 3, Example 4 and Comparative Example 2 that with the same formula, increasing the pressure retaining temperature can improve the temperature resistance of the product, and even a product with a temperature resistance of above 100° C. can be produced, which can achieve the same temperature resistance effect as that of a conventional heat-treated sample, but the shapes of the samples of the present disclosure can be kept to be substantially unchanged; when the pressure retaining temperature is increased so that the temperature resistance of the product is enhanced, the bending and embrittlement resistance thereof decreases, but is still better than that in Comparative Example 2, and the product in the comparative example has a smaller breaking pushing distance, i.e., a poorer bending and embrittlement resistance, than the corresponding broken sample in Example 4.

### Example 5

PLA knife/fork/spoon preforms with formula composition Nos. 05 and 09 are placed in a mold container at 50° C., carbon dioxide is injected into the container at a pressure of 10 MPa, the preforms are soaked at constant temperature and pressure for 60 minutes, rapid pressure release at a speed of 34 MPa/s is performed, the mold is opened to take out the samples, and the samples are cooled at room temperature to obtain PLA knife/fork/spoon product. The samples are tested for density, temperature resistance, and bending and embrittlement resistance and the results are as shown in Table 2. After carbon dioxide treatment, the samples are white, the densities of Nos. 05 and 09 are decreased by 29.0% and 25.8% respectively, and the temperature resistance is 70° C. or below; and the samples are not broken in the bending resistance test.

### Example 6

PLA knife/fork/spoon preforms with formula composition Nos. 05-07, 09 and 010 are placed in a mold container at 60° C., carbon dioxide is injected into the container at a pressure of 9.5 MPa, the preforms are soaked at constant temperature and pressure for 15 minutes, rapid pressure release at a speed of 33 MPa/s is performed, the mold is opened to take out the samples, and the samples are cooled at room temperature to obtain PLA knife/fork/spoon product. The samples are tested for density, temperature resistance, and bending and embrittlement resistance and the results are as shown in Table 2. After carbon dioxide treatment, the samples are white, and the densities of the Nos. 05-07, 09 and 010 samples are decreased by 12.4%, 15.1%, 11.3%, 8.9% and 10.7% respectively, the Nos. 05 and 010 knives/forks/spoons have a temperature resistance of 70° C. or below, the Nos. 06 and 07 knives/forks/spoons have a temperature resistance of 65° C. or below, the No. 09 knife/fork/spoon has a temperature resistance of 75° C. or below; the samples are not broken in the bending resistance test.

### Example 7

PLA knife/fork/spoon preform with formula composition No. 05 is placed in a mold container at 70° C., carbon dioxide is injected into the container at pressures of 8 MPa, 9.5 MPa and 11 MPa respectively, the preforms are soaked at constant temperature and pressure for 30 minutes, rapid pressure release at speeds of 28 MPa/s, 33 MPa/s and 38 MPa/s respectively is performed, the mold is opened to take out the samples, and the samples are cooled at room temperature to obtain PLA knife/fork/spoon product. The samples are tested for density, temperature resistance, and bending and embrittlement resistance and the results are as shown in Table 2. After carbon dioxide treatment, the samples are white, the densities of the samples are decreased by 8.9%, 22.8% and 29.6% respectively, and the temperature resistance is 70° C. or below, 75° C. or below and 75° C. or below respectively; the samples are not broken in the bending resistance test.

### Example 8

PLA knife/fork/spoon preforms with formula composition Nos. 05 and 07 are placed in a mold container at 85° C., carbon dioxide is injected into the container at a pressure of 9.5 MPa, the preforms are soaked at constant temperature and pressure for 8 minutes, rapid pressure release at a speed of 33 MPa/s is performed, the mold is opened to take out the samples, and the samples are cooled at room temperature to obtain PLA knife/fork/spoon product. The samples are tested for density, temperature resistance, and bending and embrittlement resistance and the results are as shown in Table 2. After carbon dioxide treatment, the samples are white, the densities of the Nos. 05 and 07 are decreased by 9.3% and 8.2% respectively, and the temperature resistance is 95° C. or below and 85° C. or below respectively; and the samples are broken in the bending resistance test.

### Example 9

PLA knife/fork/spoon preforms with formula composition Nos. 06, 09 and 010 are placed in a mold container at 85° C., carbon dioxide is injected into the container at a pressure of 10 MPa, the preforms are soaked at constant temperature and pressure for 6 minutes, rapid pressure release at a speed of 34 MPa/s is performed, the mold is opened to take out the samples, and the samples are cooled at room temperature to obtain PLA knife/fork/spoon product. The samples are tested for density, temperature resistance, and bending and embrittlement resistance and the results are as shown in Table 2. After carbon dioxide treatment, the samples are white, the densities of the Nos. 06, 09 and 010 samples are decreased by 7.9%, 10.4% and 20.1% respectively, and the temperature resistance is 75° C. or below, 95° C. or below and 90° C. or below respectively. The No. 06 sample is not broken in the bending resistance test, while the Nos. 09 and 010 samples are broken in the bending resistance test.

It can be seen from Examples 5-9 that after the high-pressure carbon dioxide soaking treatment, the density of PLA knife/fork/spoon can be decreased by 8%-29%, and the temperature resistance thereof can vary from 65° C. to 95° C. with the formula composition or with the treatment process conditions; and the samples of the present disclosure are substantially resistant or have improved bending and embrittlement resistance as compared with oven heat treated samples.

1. A method for preparing a thermoresistant PLA knife/fork/spoon, wherein the method comprises the following steps:
(1) preparing a knife/fork/spoon preform from a PLA knife/fork/spoon raw material via injection molding using an injection molding machine, the knife/fork/spoon preform comprising PLA that is not completely crystallized; and
(2) subjecting the knife/fork/spoon preform to carbon dioxide soaking treatment at constant temperature and pressure to crystallize the uncrystallized PLA in the knife/fork/spoon preform, so as to obtain a PLA knife/fork/spoon product with a temperature resistance of 65° C. or above;
wherein, a method of the carbon dioxide soaking treatment in step (2) comprises: placing PLA knife/fork/spoon preform in a temperature-adjustable closed container with high temperature and high pressure resistance, injecting the carbon dioxide into the closed container, and soaking at a constant temperature and under retained pressure;
in step (2), a pressure retaining temperature is 45° C.-110° C., a pressure retaining pressure is 4-12 MPa, a pressure retaining time is 6-60 minutes, and a pressure release speed is 5-45 MPa/s; and
the carbon dioxide is a supercritical carbon dioxide fluid or a subcritical carbon dioxide fluid.

2. The method for preparing the thermoresistant PLA knife/fork/spoon according to claim 1, wherein different thermoresistant knife/fork/spoon products are obtained by adjusting the formula and soaking parameters, and the products are respectively:
a thermoresistant knife/fork/spoon product having a temperature resistance of 65° C. or above and below 100° C.; and
a highly thermoresistant knife/fork/spoon product having a temperature resistance above 100° C.

3. The method for preparing the thermoresistant PLA knife/fork/spoon according to claim 1, wherein a low-density knife/fork/spoon product is obtained by adjusting the soaking parameters; the pressure retaining pressure is 7 MPa or above and below 12 MPa, and the pressure release speed is 24 MPa/s or above.

4. The method for preparing the thermoresistant PLA knife/fork/spoon according to claim 1, wherein the pressure retaining pressure is 9 MPa or above and below 10.5 MPa, and the pressure release speed is 31 MPa/s or above; a density of the resulting knife/fork/spoon product is lower than that of the knife/fork/spoon preform, and a percentage of decrease is 0%-30% with 0 excluded.

5. The method for preparing the thermoresistant PLA knife/fork/spoon according to claim 1, wherein the raw material for PLA knife/fork/spoon in step (1) comprises the following components by mass:
50%-80% of a major material;
0%-20% of an auxiliary material;
10%-30% of a filler; and
0%-5% of a modifier;
wherein the major material is PLA;
the auxiliary material is PBAT, PBS or a blend of PBAT and PBS;
the filler is selected from any one or a combination of more than one of talc, calcium carbonate, silica, bentonite, coffee grounds, and bamboo powder; and
the modifier is selected from any one or a combination of more than one of a nucleating agent, an antioxidant, an antistatic agent, an antibacterial agent, a color masterbatch, a compatibilizer, a toughening agent, a lubricant, a release agent, a chain extender, or a crosslinking agent.

6. The method for preparing the thermoresistant PLA knife/fork/spoon according to claim 5, wherein PLA is selected from a single brand or a blend of brands.

7. The method for preparing the thermoresistant PLA knife/fork/spoon according to claim 5, wherein particles prepared by an extrusion blending and pelletizing process are used as the raw material for PLA knife/fork/spoon.

8. A thermoresistant PLA knife/fork/spoon prepared by the preparing method according to claim 1, wherein the knife/fork/spoon is a microfoaming product with a density reduced by 5% to 30% relative to the knife/fork/spoon preform, and the knife/fork/spoon has a temperature resistance of 65° C. or above.
